(19) United States
(12) Patent Application Publication
(10) Pub. No.: US 2017/0346512 A1
(43) Pub. Date: Nov. 30, 2017

(54) METHOD FOR RECEIVING DATA IN MIMO MOLECULAR COMMUNICATION SYSTEM

(71) Applicant: INDUSTRY-ACADEMIC COOPERATION FOUNDATION, YONSEI UNIVERSITY, Seoul (KR)

(72) Inventors: Chan-Byoung CHAE, Seoul (KR); Bon-Hong KOO, Incheon (KR); Yae Jee CHO, Incheon (KR)

(21) Appl. No.: 15/605,596

(22) Filed: May 25, 2017

(30) Foreign Application Priority Data
May 25, 2016 (KR) 10-2016-0063985

(51) Int. Cl. H04B 1/10; H04B 7/08; H04B 7/0413

(52) U.S. Cl. CPC H04B 1/10; H04B 7/0413; H04B 7/08

(57) ABSTRACT

Disclosed is a method for receiving data that can reduce intersymbol interference (ISI) and interlink interference (ILI) occurring in a MIMO molecular communication system. An embodiment of the present invention provides a method for receiving data at a receiver in a MIMO molecular communication system, where the method includes: determining an enzyme inhibitor discharge stopping timepoint by using the distance between the antennas of the transmitter and the distance between the transmitter and the receiver; discharging an enzyme inhibitor, which is configured to deactivate an enzyme that is distributed around the receiver, and receiving a molecule transmitted from the transmitter; and stopping the discharge of the enzyme inhibitor according to the enzyme inhibitor discharge stopping timepoint, and where the enzyme is reactive to the molecule.

### CROSS-REFERENCE TO RELATED APPLICATIONS

This application claims the benefit of Korean Patent Application No. 10-2016-0063985, filed with the Korean Intellectual Property Office on May 25, 2016, the disclosure of which is incorporated herein by reference in its entirety.

### BACKGROUND

### 1. Technical Field

The present invention relates to a method for receiving data in a MIMO molecular communication system, more particularly to a method for receiving data that can reduce intersymbol interference (ISI) and interlink interference (ILI) occurring in a MIMO molecular communication system.

### 2. Description of the Related Art

Molecular communication is receiving attention in recent times as an alternative method of communication. Molecular communication is a means of communication that uses molecules as a medium, unlike existing communication methods that use radio waves as the medium. Just as existing radio wave communication methods transferred information by altering phase, amplitude, frequency, and the like, molecular communication transfers information by altering the concentration, type, arrival time, and the like. The information requiring transference may be converted into certain molecular states using the modes described above, and when the molecules sent from the transmitter via diffusion or via a flow of a medium arrive at the receiver, the transfer of information may be achieved. Much research is being focused on molecular communication due to the many advantages it holds over methods that use radio waves as the medium, especially in the context of nanoscale communication in which the transmitter and receiver become extremely small. In particular, active research is under way that aims to utilize molecular communication in the fields of human body communication, medical equipment, and the like.

Many existing research efforts on molecular communication are based on a single input/output system, but the single input/output system is limited in providing a desired transmission speed. In particular, while molecular communication transfers information by using the diffusion of molecules, the diffusion speed may be much slower compared to the transfer speed of radio waves, and as such, molecular communication techniques based on a multiple input multiple output (MIMO) system are being studied for improving the transmission speeds associated molecular communication. FIG. 1 is a diagram illustrating a multiple input/output molecular communication system.

Referring to FIG. 1, a transmitter 110 may convert the transmitted data to an amount of molecules according to a preset modulation method and may discharge the molecules from two transmitter antennas Tx1, Tx2. The channel (link) through which the molecules move may be a fluid and may allow movement via diffusion. The transmitter antenna can have the form of a dot of a scale that allows the discharging of molecules.

The two receiver antennas Rx1, Rx2 of a receiver 120 may receive the molecules by using receptors, and the received molecules may be converted into data according to a preset demodulation method. The receiver antenna can have the form of a sphere to facilitate the absorption of the molecules.

Since the molecules move via diffusion in a multiple input/output molecular communication system, depending on the transmission environment, there may be occurrences in which certain molecules that were discharged first move at an excessively slow speed and become mixed with other molecules that were discharged later on as they arrive at the receiver, resulting in intersymbol interference (ISI).

Furthermore, it is difficult to control the molecules discharged from a first transmitter antenna Tx1 such that they are sent only to the first receiver antenna Rx1, as in the case of beam forming used by radio communication. The molecules discharged from the first transmitter antenna Tx1 may move to both the first and the second receiver antenna Rx1, Rx2, resulting in interlink interference (ILI). That is, as the second receiver antenna also receives the undesired molecules of the first transmitter antenna, the molecules of the first transmitter antenna cause interlink interference from the perspective of the second receiver antenna.

Thus, applying a multiple input/output system to molecular communication is vulnerable to interference, such as intersymbol interference and interlink interference, and since beam forming and other error correction techniques, as used in existing wireless communication methods that use radio waves, are difficult to apply to molecular communication, there is a need for a method of eliminating interference in a MIMO molecular communication system that takes into account the properties of molecular communication.

Examples of relevant prior art documents include Korean Patent Publication No. 2015-0079357, as well as academic papers “Molecular MIMO Systems: Algorithms and Implementations,” authored by Lee Chang-Min, Koo Bon-Hong, and Chae Chan-Byung and published at the 2014 Autumn 2014 Autumn General Conference of the Korean Institute of Communications and Information Sciences, and “Improving Receiver Performance of Diffusive Molecular Communication with Enzymes,” authored by Adam Noel, Karen C. Cheung, and Robert Schober, and published by the IEEE in 2013.

### SUMMARY OF THE INVENTION

An aspect of the present invention is to provide a method for receiving data that can reduce intersymbol interference (ISI) and interlink interference (ILI) that occur in a MIMO molecular communication system.

To achieve the objective above, an embodiment of the present invention provides a method for receiving data at a receiver in a MIMO molecular communication system, where the method includes: determining an enzyme inhibitor discharge stopping timepoint by using the distance between the antennas of the transmitter and the distance between the transmitter and the receiver; discharging an enzyme inhibitor, which is configured to deactivate an enzyme that is distributed around the receiver, and receiving a molecule transmitted from the transmitter; and stopping the discharge of the enzyme inhibitor according to the enzyme inhibitor discharge stopping timepoint, and where the enzyme is reactive to the molecule.

Also, to achieve the objective above, another embodiment of the invention provides a method for receiving data at a receiver in a MIMO molecular communication system, where the method includes: determining a receiver open-mode period and a receiver closed-mode period by using the distance between the antennas of the transmitter and the distance between the transmitter and the receiver; discharging an enzyme inhibitor, which is configured to deactivate an enzyme that is distributed around the receiver, and receiving a molecule transmitted from the transmitter during the receiver open-mode period; and stopping the discharge of the enzyme inhibitor during the receiver closed-mode period following the receiver open-mode period, and where the enzyme is reactive to the molecule.

Also, to achieve the objective above, another embodiment of the invention provides a method for receiving data at a receiver in a MIMO molecular communication system, where the method includes: receiving a molecule transmitted from a transmitter during a receiver open-mode period; activating a molecule-blocking filter around the receiver during a receiver closed-mode period following the receiver open-mode period; and recovering data by counting the number of received molecules.

An embodiment of the invention can reduce interference by using a molecule-blocking filter to block molecules that cause interference so that such molecules cannot be received at the receiver.

Also, an embodiment of the invention can reduce interference by using an enzyme as a molecule-blocking filter and an enzyme inhibitor.

### BRIEF DESCRIPTION OF THE DRAWINGS

FIG. 1 is a diagram illustrating a multiple input/output molecular communication system.

FIG. 2 is a graph illustrating the principle of a method for receiving data in a MIMO molecular communication system according to an embodiment of the invention.

FIGS. 3A and 3B are diagram illustrating a MIMO molecular communication system according to an embodiment of the invention.

FIG. 4 is a diagram illustrating a receiver open-mode period and a receiver closed-mode period.

FIG. 5 is a diagram illustrating a receiver antenna according to an embodiment of the invention and enzymes distributed around the receiver antenna.

FIG. 6 is a diagram illustrating a method for receiving data at a receiver in a MIMO molecular communication system according to an embodiment of the invention.

FIG. 7 is a diagram illustrating a method for receiving data at a receiver in a MIMO molecular communication system according to another embodiment of the invention.

FIG. 8 is a diagram illustrating a method for receiving data at a receiver in a MIMO molecular communication system according to yet another embodiment of the invention.

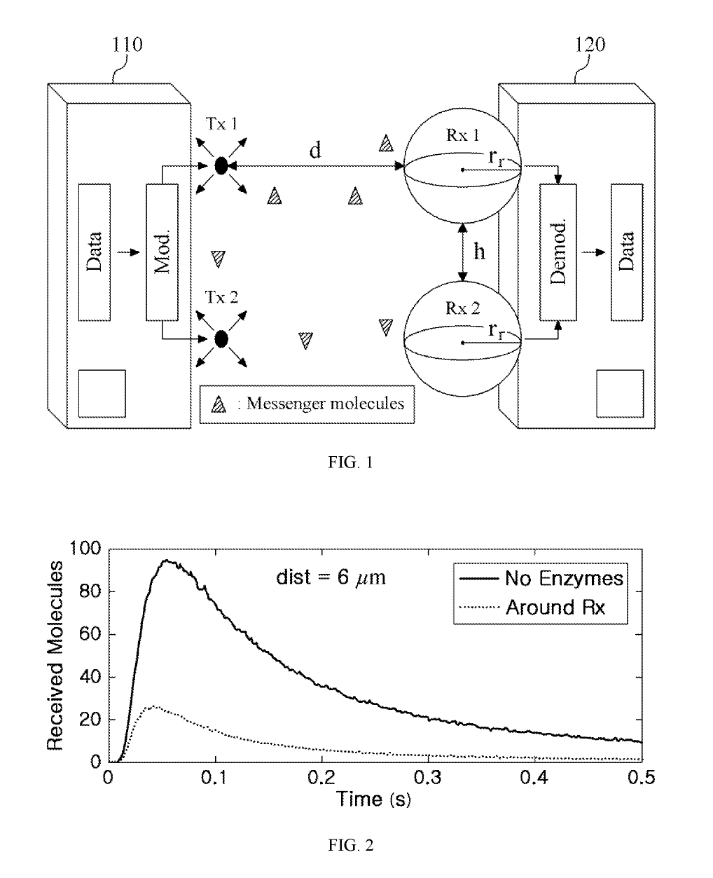

### DETAILED DESCRIPTION OF THE INVENTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In describing the drawings, like reference numerals are used for like elements.

An aspect of the present invention is to propose a method for receiving data that can reduce interference components when a receiver in a MIMO molecular communication system receives molecules.

As described above, molecular communication entails molecules moving by way of diffusion, and the inherent properties of diffusion can cause intersymbol interference or interlink interference. To reduce such interference, an embodiment of the present invention may use a molecule-blocking filter positioned around the receiver, where the molecule-blocking filter may be activated when molecules of interference components approach the receiver so that the receiver cannot receive the interference component molecules.

An embodiment may use an enzyme or an enzyme inhibitor for the molecule-blocking filter. The enzyme may react with the molecules to block the reception of the molecules at the receiver, while the enzyme inhibitor may deactivate the enzyme.

While the descriptions that follow concentrate on embodiments that utilize an enzyme or an enzyme inhibitor as the molecule-blocking filter, other embodiments may use different forms, such as a membrane, etc., for the molecule-blocking filter. For example, the size of the pores in the membrane can be controlled to allow or block the passage of molecules through the molecule-blocking filter.

Certain embodiments of the present invention are described below in more detail with reference to the accompanying drawings.

FIG. 2 is a graph illustrating the principle of a method for receiving data in a MIMO molecular communication system according to an embodiment of the invention, where the graph plots the number of received molecules for one case in which there are enzymes distributed around the receiver (Around Rx) and one case in which there are no enzymes distributed around the receiver (No Enzymes), under the condition that the transmitter and the receiver are separated by a particular distance (6 μm).

An embodiment of the invention may use an enzyme and an enzyme to reduce intersymbol interference and interlink interference.

The enzyme may react with molecules that are transmitted from the transmitter for information transfer and may decompose the molecule or change its property so that the molecule is not received by the receptor of the receiver. That is, from the perspective of the receiver, the enzyme may operate as a molecule-blocking filter.

The enzyme inhibitor may deactivate the enzyme to inhibit its reaction with the transmitted molecules. That is, from the perspective of the receiver, the enzyme inhibitor may serve to deactivate the molecule-blocking filter.

Thus, an embodiment of the invention can reduce interference by using the enzyme to prevent those molecules that cause interference from being received at the receiver. Also, an embodiment of the invention can permit the reception of desired molecules by using the enzyme inhibitor to deactivate or remove the enzyme, in order that the molecules transferring information can be received at the receiver.

From FIG. 2, it can be seen that the case having the enzyme distributed around the receiver has a decreased number of received molecules compared to the case having no enzymes. Therefore, by providing proper control such that the enzyme reacts with those molecules that cause interference before said molecules are positioned in the vicinity of and are received by the receiver, it is possible to reduce interference.

Some examples of molecules that can be used for transmitting information along with the enzyme and enzyme inhibitor that can be used in conjunction with the molecules according to an embodiment of the invention are shown below in Table 1.

TABLE 1

| Molecule | Enzyme | Enzyme Inhibitor |
|---|---|---|
| acetylcholine | acetylcholinesterase | DIFP (diisopropyl |
| | | phosphorofluoridate) |
| alcohol | alcohol dehydrogenase | thiolane 1-oxides |
| | | fomepizole |
| | | alkylating agent |
| tryptophan | chymotrypsin | TPCK (tosyl phenylalanine |
| | | chloromethyl ketone) |

Acetylcholinesterase decomposes acetylcholine into choline and acetate. Alcohol dehydrogenase is an enzyme that oxidizes ethanol into acetaldehyde. Chymotrypsin is a proteolytic enzyme.

Depending on whether or not the deactivated enzyme can recover its function, enzyme inhibitors can be divided into irreversible inhibitors and reversible inhibitors, and both irreversible inhibitors and reversible inhibitors can be utilized in different embodiments of the invention. However, since the interference removal effect of a reactivated enzyme may not be as strong, it may be preferable to use an irreversible inhibitor for the enzyme inhibitor.

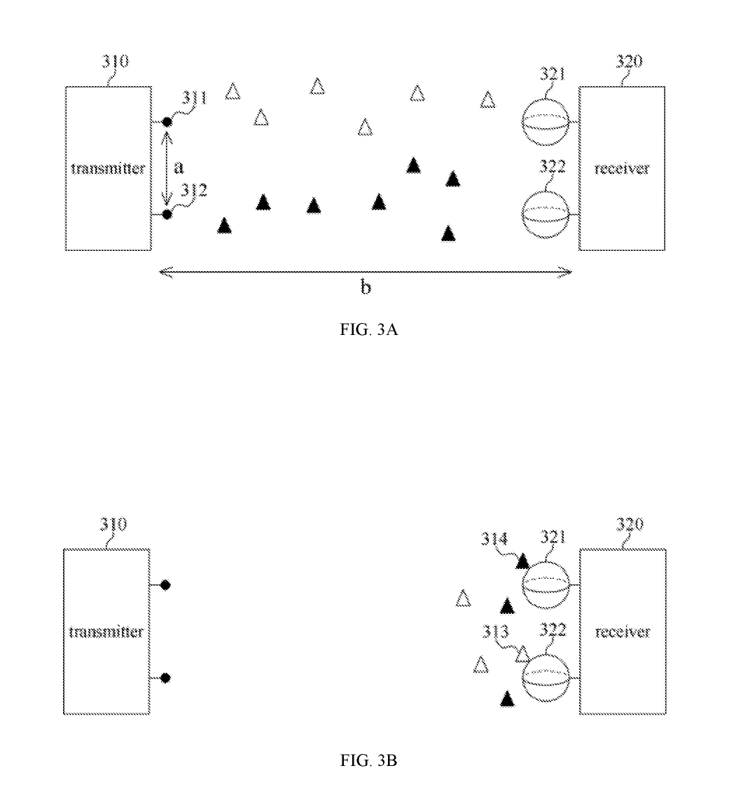

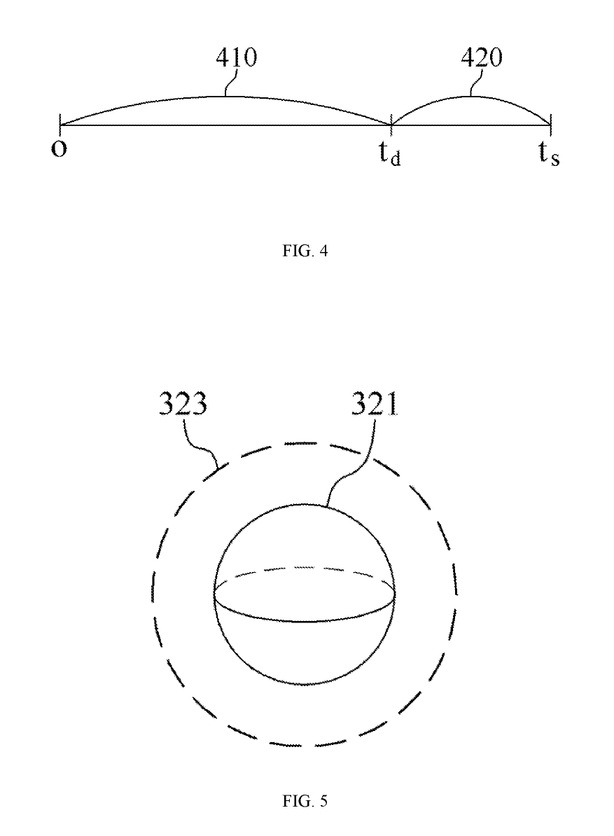

FIGS. 3A and 3B are a diagram illustrating a MIMO molecular communication system according to an embodiment of the invention, and FIG. 4 is a diagram illustrating a receiver open-mode period and a receiver closed-mode period.

In FIG. 3A, white triangles represent molecules discharged from a first transmitting antenna 311 towards a first receiving antenna 321, and black triangles represent molecules discharged from a second transmitting antenna 312 towards a second receiving antenna 322.

Referring to FIG. 3B, a MIMO molecular communication system according to an embodiment of the invention may include a transmitter 310 and a receiver 320, with the transmitter 310 and the receiver 320 each including a multiple number of antennas. Although FIGS. 3A and 3B illustrate an example of a MIMO system that includes two transmitting antennas 311, 312 and two receiving antennas 321, 322, various different embodiments can be designed to have different numbers of antennas.

An enzyme that is reactive to the molecules transmitted from the transmitter 310 may be distributed around the receiver 320. Depending on the embodiment, the distribution of the enzyme around the receiver 320 can be achieved by positioning the receiver 320 in an environment in which the enzyme was already distributed beforehand or by having the receiver 320 discharge the enzyme. For example, in cases where a MIMO molecular communication system according to an embodiment of the invention is used within a digestive organ of a human body, the receiver 320 can be positioned in an environment that has the chymotrypsin enzyme distributed therein.

The receiving antennas 321, 322 of the receiver 320 can have minute holes formed in the surfaces for discharging the enzyme and enzyme inhibitor, and the concentration of the enzyme distributed around the receiver 320 can be set to various levels according to the amount of enzyme discharged by the receiver 320.

The transmitter 310 may transmit a predetermined amount of molecules according to a preset transmission cycle is as illustrated in FIG. 4. In one example, the transmitter 310 can transmit the molecules by using a BCSK (binary concentration shift keying) modulation scheme. For example, if the information to be transferred is the alphabet letter “A,” then the transmitter 310 may convert the letter “A” to its corresponding binary number “11000” and transmit molecules during just the first and second transmission cycles out of five transmission cycles. That is, the transmitter 310 may transmit molecules only for the binary number “1.”

The receiver 320 may count the numbers of molecules received during the respective transmission cycles and compare the counted value with a threshold value to recover data.

As illustrated in FIG. 3A, the receiver 320 may discharge an enzyme inhibitor that deactivates the enzyme distributed around the receiver 320, during a receiver open-mode period 410, to receive the molecules sent from the transmitter 310. Then, as shown in FIG. 3B, which represents a state after the molecules have diffused from the state shown in FIG. 3A, the receiver 320 may stop the discharge of the enzyme inhibitor during a receiver closed-mode period 420 following the receiver open-mode period 410, as illustrated in FIG. 4.

During the receiver open-mode period 410, the enzyme may be deactivated, allowing the receiver 320 to receive molecules. During the receiver closed-mode period 420, the discharge of the enzyme inhibitor may be stopped, and the enzyme may be discharged, making it difficult for the receiver 320 to receive molecules due to the activation of the enzyme.

That is, in FIG. 3B, the molecules 313 sent from the first transmitting antenna 311 are an interlink interference component, but even if they contact the second receiving antenna 322, the molecules 313 may be decomposed by the enzyme and thus may not be received by the second receiving antenna 322. Likewise, the molecules 314 sent from the second transmitting antenna 312 as an interlink interference component may contact the first receiving antenna 321, but the molecules 314 may be decomposed by the enzyme and may not be received by the first receiving antenna 321. During the receiver closed-mode period 420, the reception of molecules that correspond to interference components may be blocked.

The receiver open-mode period 410 and the receiver closed-mode period 420 may be determined within a transmission cycle, and the beginning of the receiver closed-mode period can be determined as the timepoint at which the probability of interference occurring is high. Thus, in determining the receiver closed-mode period, it may be desirable to consider the timepoints at which there are a high probability of molecules sent during a first cycle being received at the receiver during the next, second cycle (probability of intersymbol interference) and a high probability of molecules sent from an undesired link being received at the receiver (probability of interlink interference).

A timepoint at which the probability of such types of interference occurring is high may be associated with the distance between the transmitting antennas and the distance between the transmitter and the receiver. This is because a greater distance between the transmitter and the receiver and a greater distance between the transmitting antennas would lead to a longer time required by the molecules to reach the receiver by diffusion. Thus, the receiver 320 may determine the receiver open-mode period 410 and the receiver closed-mode period 420 by using the distance a between the antennas of the transmitter and the distance b between the transmitter 310 and the receiver 320, as illustrated in FIG. 3A.

The length of the receiver open-mode period can be determined to be increased in proportion to the distance between the transmitter antennas and the distance between the transmitter and the receiver. In other words, the timepoint of the receiver closed-mode period can be determined to increase in proportion to the distance between the transmitter antennas and the distance between the transmitter and the receiver, from the timepoint of the receiver open-mode period. That is, the greater the distance between the transmitter antennas and the greater the distance between the transmitter and the receiver, the later the enzyme inhibitor discharge stopping timepoint.

In a different embodiment, the receiver 320 can receive molecules without discharging either an enzyme or an enzyme inhibitor during the receiver open-mode period 410 and can block the reception of molecules corresponding to an interference component by discharging an enzyme during the receiver closed-mode period 420. However, since having a certain concentration of enzymes distributed around the receiver may be more advantages in terms of removing interference, and since the enzyme inhibitor does not deactivate all of the enzymes around the receiver, it can be preferable to employ the method of discharging an enzyme inhibitor during the receiver open-mode period 410 for enhancing the interference removal effect.

FIG. 5 is a diagram illustrating a receiver antenna according to an embodiment of the invention and enzymes distributed around the receiver antenna, which may be one of the receiver antennas shown in FIG. 3A.

As illustrated in FIG. 5, a molecule-blocking filter 323 can be positioned around a receiving antenna 321, and in one embodiment, the molecule-blocking filter 323 can be a region having enzymes distributed therein. That is, the molecule-blocking filter 323 can correspond to a range within which enzymes are distributed, and the enzyme distribution range of FIG. 5 may represent a distribution range 323 in which the enzymes are distributed in a concentration of a particular level or higher.

In the receiver open-mode period, the enzymes within the distribution range 323 may be deactivated as the enzyme inhibitor is discharged by the receiver. That is, the molecule-blocking filter 323 may be deactivated. Therefore, the molecules can be received by the receiving antenna 321.

Conversely, in the receiver closed-mode period, the discharge of the enzyme inhibitor by the receiver may be stopped, and the enzyme may be discharged, so that active enzymes are present within the distribution range 323. That is, the molecule-blocking filter 323 may be activated. Therefore, if a molecule enters the distribution range 323, it may be decomposed by the enzyme and may not be received by the receiving antenna 321.

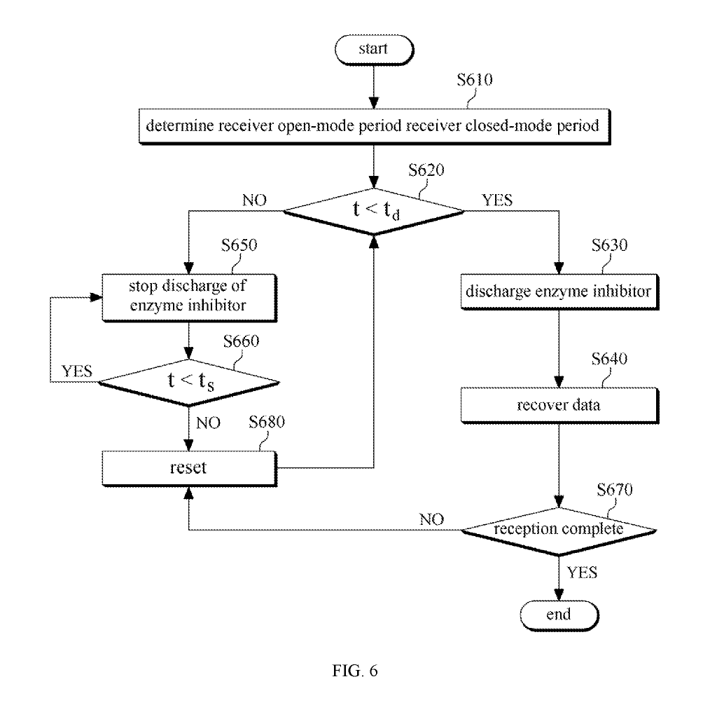

FIG. 6 is a diagram illustrating a method for receiving data at a receiver in a MIMO molecular communication system according to an embodiment of the invention.

A receiver according to an embodiment of the invention may determine the receiver open-mode period and the receiver closed-mode period by using the distance between the transmitter antennas and the distance between the transmitter and the receiver (operation S610). That is, the receiver can determine the starting point (td) of the receiver closed-mode period, which is also the ending point of the receiver open-mode period.

The receiver may then determine whether the current timepoint corresponds to the receiver open-mode period or the receiver closed-mode period (operation S620). The receiver can use a counter to determine whether or not the current timepoint is within the receiver open-mode period 410.

If the result of the determining shows that the current timepoint corresponds to the receiver open-mode period, the receiver may discharge the enzyme inhibitor (operation S630) and may count the received molecules to recover data (operation S640). Conversely, if the result of the determining shows that the current timepoint corresponds to the receiver closed-mode period, the receiver may stop the discharging of the enzyme inhibitor (operation S650). Here, the receiver 320 can stop the discharge of the enzyme inhibitor concurrently with entering the receiver closed-mode period 420 or can stop the discharge of the enzyme inhibitor with a time difference after entering the receiver closed-mode period 420.

Afterwards, the receiver may determine whether or not the receiver closed-mode period has ended and whether or not molecules have been received (operations S660, S670), and if the receiver closed-mode period has ended and there is a need for the receiving of the molecules to continue, the receiver may reset the counter (operation S680) and return to operation S620.

According to the number of molecules received during the receiver open-mode period, the receiver in operation S610 can adjust the receiver open-mode period and receiver closed-mode period.

Since the enzyme is deactivated during the receiver open-mode period as described above, a plot of the number of received molecules may correspond to the solid line in the graph of FIG. 2. That is, as the number of received molecules gradually decreases from the peak value during the receiver open-mode period, if there is an increase in the number or a reduction in the amount of decrease in the number at a particular timepoint, the receiver may determine that an interference has occurred and can adjust the receiver open-mode period and receiver closed-mode period accordingly.

Suppose, for example, that in the example referenced in FIG. 2, the receiver open-mode period is from the 0 second timepoint to the 0.4 second timepoint, and the receiver closed-mode period is from the 0.4 second timepoint to the 0.5 second timepoint. If the number of received molecules increases again at the 0.3 second timepoint, then the receiver can adjust the receiver open-mode period to be from the 0 second timepoint to the 0.3 second timepoint and adjust the receiver closed-mode period to be from the 0.3 second timepoint to the 0.5 second timepoint.

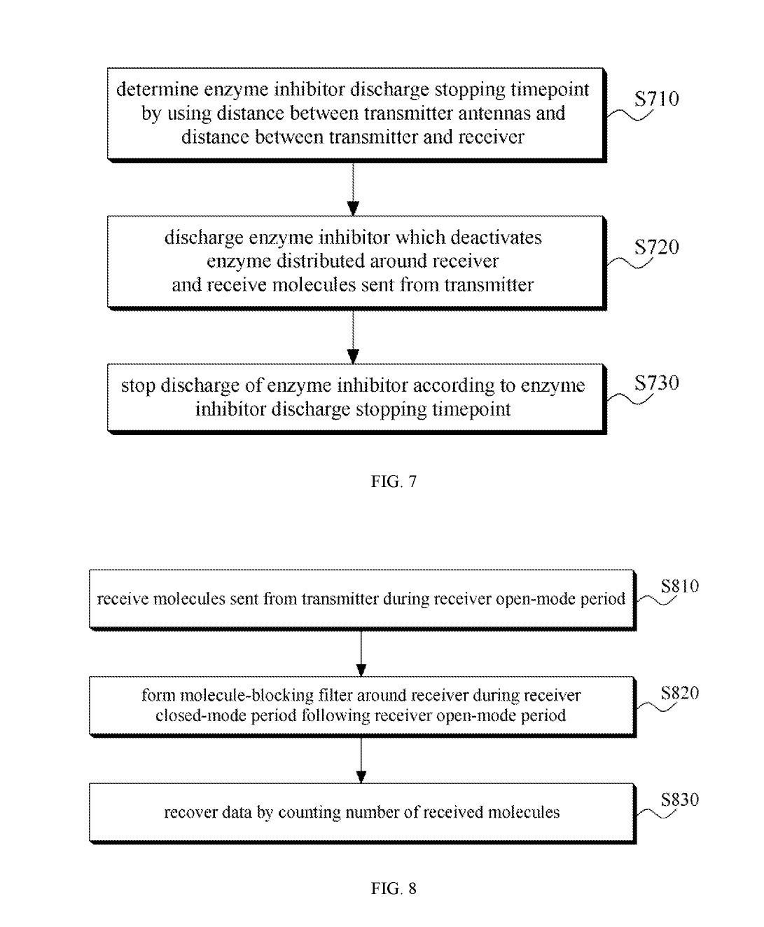

FIG. 7 is a diagram illustrating a method for receiving data at a receiver in a MIMO molecular communication system according to another embodiment of the invention.

A receiver according to an embodiment of the invention may determine an enzyme inhibitor discharge stopping timepoint by using the distance between the transmitter antennas and the distance between the transmitter and the receiver (operation S710). Here, the enzyme inhibitor discharge stopping timepoint can increase in proportion to the distance between the transmitter antennas and the distance between the transmitter and the receiver, from the timepoint at which the discharge of the enzyme inhibitor begins.

The receiver may discharge the enzyme inhibitor, which deactivates the enzymes distributed around the receiver, and may receive the molecules sent from the transmitter (operation S720). Then, the discharge of the enzyme inhibitor may be stopped according to the enzyme inhibitor discharge stopping timepoint (operation S730).

At a preset duration of time after the enzyme inhibitor discharge stopping timepoint, the receiver may again discharge the enzyme inhibitor to receive molecules, where the preset duration of time can be determined according to the transmission cycle of the transmitter.

Then, the receiver can stop the discharge of the enzyme inhibitor and discharge the enzyme. Here, the enzyme can be discharged at the same time the discharge of the enzyme inhibitor is stopped or after a certain duration of time.

FIG. 8 is a diagram illustrating a method for receiving data at a receiver in a MIMO molecular communication system according to yet another embodiment of the invention.

A receiver according to an embodiment of the invention may receive the molecules from the transmitter during a receiver open-mode period (operation S810), and during a receiver closed-mode period following the receiver open-mode period, may activate a molecule-blocking filter around the receiver (operation S820).

In cases where the receiver is positioned in an environment having an enzyme distributed therein that is reactive to the molecules, the receiver may discharge an enzyme inhibitor in operation S810 and deactivate the discharge of the enzyme inhibitor in operation S820. Alternatively, the receiver can activate the molecule-blocking filter by discharging an enzyme that is reactive to the molecules in operation S820.

The receiver may count the number of molecules received in operation S810 to recover the data (S830).

As described above, the receiver can consider the distance between the transmitter antennas and the distance between the transmitter and the receiver in determining the receiver open-mode period and closed-mode period, and in certain embodiments, the receiver can consider at least one of the distance between transmitter antennas and the distance between the transmitter and receiver. For instance, if the distance between the transmitter antennas is negligibly small compared to the distance between the transmitter and the receiver, the receiver can determine the receiver open-mode period and closed-mode period by using just the distance between the transmitter and the receiver.

It is also possible for the receiver to receive the molecules or activate the molecule-blocking filter by using information on a receiver open-mode period and closed-mode period that were determined beforehand.

The technology described above can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the invention or can be a type of medium known to and used by the skilled person in the field of computer software. A computer-readable medium may include a hardware device that is specially configured to store and execute program instructions. Some examples may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc. Examples of the program of instructions may include not only machine language codes produced by a compiler but also high-level language codes that can be executed by a computer through the use of an interpreter, etc. The hardware mentioned above can be made to operate as one or more software modules that perform the actions of the embodiments of the invention, and vice versa.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention. Thus, the spirit of the present invention is not to be confined to the embodiments described above but rather encompasses all equivalents and variations.

What is claimed is:

1. A method for receiving data at a receiver in a MIMO molecular communication system, the method comprising:
determining an enzyme inhibitor discharge stopping timepoint by using a distance between antennas of a transmitter and a distance between the transmitter and the receiver;
discharging an enzyme inhibitor and receiving a molecule transmitted from the transmitter, the enzyme inhibitor configured to deactivate an enzyme distributed around the receiver; and
stopping a discharge of the enzyme inhibitor according to the enzyme inhibitor discharge stopping timepoint,
wherein the enzyme is reactive to the molecule.

2. The method for receiving data according to claim 1, wherein the enzyme inhibitor discharge stopping timepoint increases in proportion to the distance between the transmitter antennas and the distance between the transmitter and the receiver, from a timepoint of the discharging of the enzyme inhibitor.

3. The method for receiving data according to claim 1, wherein the receiving of the molecule comprises:
discharging the enzyme inhibitor after a preset duration of time from the enzyme inhibitor discharge stopping timepoint.

4. The method for receiving data according to claim 1, further comprising:
discharging the enzyme according to the enzyme inhibitor discharge stopping timepoint.

5. A method for receiving data at a receiver in a MIMO molecular communication system, the method comprising:
determining a receiver open-mode period and a receiver closed-mode period by using a distance between antennas of a transmitter and a distance between the transmitter and the receiver;
discharging an enzyme inhibitor and receiving a molecule transmitted from the transmitter during the receiver open-mode period, the enzyme inhibitor configured to deactivate an enzyme distributed around the receiver; and
stopping a discharge of the enzyme inhibitor during the receiver closed-mode period following the receiver open-mode period,
wherein the enzyme is reactive to the molecule.

6. The method for receiving data according to claim 5, wherein the transmitter transmits the molecule according to a preset transmission cycle, and
the receiver open-mode period and the receiver closed-mode period are determined within the transmission cycle.

7. The method for receiving data according to claim 6, wherein a length of the receiver open-mode period increases in proportion to the distance between the transmitter antennas and the distance between the transmitter and the receiver.

8. The method for receiving data according to claim 5, wherein the determining of the receiver open-mode period and the receiver closed-mode period comprises:
adjusting the receiver open-mode period and the receiver closed-mode period according to a number of molecules received during the receiver open-mode period.

9. The method for receiving data according to claim 5, further comprising:
discharging the enzyme during the receiver closed-mode period.

10. The method for receiving data according to claim 5, wherein the receiving of the molecule comprises:
recovering data by counting a number of molecules and comparing a counted value with a threshold value.

11. A method for receiving data at a receiver in a MIMO molecular communication system, the method comprising:
receiving a molecule transmitted from a transmitter during a receiver open-mode period;
activating a molecule-blocking filter around the receiver during a receiver closed-mode period following the receiver open-mode period; and
recovering data by counting a number of the received molecules.

12. The method for receiving data according to claim 11, wherein the receiver is located in an environment having an enzyme reactive to the molecule distributed therein, and
the activating of the molecule-blocking filter comprises:
deactivating a discharge of an enzyme inhibitor activated during the receiver open-mode period.

13. The method for receiving data according to claim 11, wherein the activating of the molecule-blocking filter comprises:
activating the molecule-blocking filter by discharging an enzyme reactive to the molecule.

14. The method for receiving data according to claim 11, further comprising:
determining the receiver open-mode period and the receiver closed-mode period by using at least one of a distance between antennas of the antenna and a distance between the transmitter and the receiver.
